(19) United States
(12) Patent Application Publication
(10) Pub. No.: US 2007/0118744 A1
(43) Pub. Date: May 24, 2007

(54) System and method for managing user equipment to access networks by using generic authentication architecture

(75) Inventor: Yingxin Huang, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Huawei Technologies Co., Ltd., Shenzhen (CN)

(21) Appl. No.: 11/585,704

(22) Filed: Oct. 24, 2006

Related U.S. Application Data
(63) Continuation of application No. PCT/CN05/00899, filed on Jun. 22, 2005.

(30) Foreign Application Priority Data
Jun. 28, 2004 (CN) 200410060128.3

(51) Int. Cl. H04L 9/00

(52) U.S. Cl. 713/168

(57) ABSTRACT

The present invention discloses a method for managing user equipment (UE) to access the network by using Generic Authentication Architecture. The basic technical solution of the present invention is that upon receiving a B-TID query request from a NAF, a network function which provides query information determines whether the UE is authorized to use the service in the network. If yes, the network function returns a successful query response carrying the information queried by the NAF to the NAF, and then, the NAF communicates with the UE according to the successful query response; otherwise, the network function returns a failed query response to the NAF and the NAF rejects the access from the UE. A system for managing user equipment to access networks by using Generic Authentication Architecture is also disclosed, which includes a Network Application Function (NAF) and a network function to control the UE network service utilizing conditions.

This application is a continuation of International Patent Application No. PCT/CN2005/000899, filed Jun. 22, 2005, which claims priority to Chinese Patent Application No. 200410060128.3, filed Jun. 28, 2004, all of which are hereby incorporated by reference.

### FIELD OF THE INVENTION

The present invention relates to the 3G wireless communication technology, and more specifically, to a system and a method for managing user equipment to access networks by using Generic Authentication Architecture.

### BACKGROUND OF THE INVENTION

In the 3G wireless communication standards, Generic Authentication Architecture is a general framework used by a plurality of services for checking and authenticating. The service may be a multicast/broadcast service, a subscriber certificate service, an instant message service, or a proxy service.

A structure of the Generic Authentication Architecture is shown in FIG. 1, in which the Generic Authentication Architecture includes user equipment (UE) 101, a Bootstrapping Server Function (BSF) 102, a Home Subscriber System (HSS) 103 and a Network Application Function (NAF) 104. The BSF 102 is provided for performing mutual authentication and generating a shared key with the UE 101. The HSS 103 serves for storing UE Profile which indicates UE information. The HSS 103 still has function of generating authentication information. The UE Profile generally refers to some relevant information of the Generic Authentication Architecture and all applied User Security Setting (USS). Each service corresponds to an application-associated security parameter aggregation, i.e., an information aggregation of the USS. The aggregate of all USS for one UE is called a GBA User Security Setting (GUSS).

When it wants to access a certain service, if the UE knows that it should perform a mutual authentication with the BSF, the UE communicates with the BSF and performs mutual authentication directly; otherwise, the UE communicates with the NAF corresponding to the service. If the NAF uses Generic Authentication Architecture and needs mutual authentication performed between the UE and the BSF, the NAF notifies the UE to perform authentication using Generic Authentication Architecture; otherwise, the NAF performs other corresponding processes.

The mutual authentication between the UE and the BSF is described hereinafter. Upon having received an authentication request from the UE, the BSF acquires the UE authentication information of the UE from the HSS, and then performs mutual authentication with the UE by executing Authentication and Key Agreement (AKA) protocol according to the obtained authentication information. When the authentication succeeds, the UE and the BSF agree to each other and generate a shared key Ks therebetween. Then, the BSF assigns the UE a Bootstrapping Transaction Identifier (B-TID) relevant to the Ks.

Upon receiving the B-TID, the UE resends to the NAF a connecting request carrying the B-TID. At the same time, the UE side works out a derived key Ks_NAF according to the Ks. Upon receiving the connecting request, the NAF queries whether there is a B-TID identical to the B-TID carried by the UE in local. If the NAF cannot find the B-TID in local, the NAF sends a query request to the BSF, and this query request carries a NAF identifier and the B-TID. If the BSF cannot find the B-TID in local, the BSF informs the NAF that the UE information does not exist. In this case, the NAF informs the UE to perform an authentication with the BSF. If the BSF finds the B-TID, the BSF works out the derived key Ks_NAF using the same algorithm used by the UE for working out the derived key Ks_NAF, and then sends to the NAF a successful response message which carries the B-TID needed by the NAF, the derived key Ks_NAF corresponding to the B-TID and a valid period of the Ks_NAF set by the BSF. Upon receiving the successful response message, the NAF regards the UE as a legal UE authenticated by the BSF and shares the Ks_NAF with the UE. The subsequent communication process between the NAF and the UE is protected by the Ks_NAF.

However, in the existing Generic Authentication Architecture, only how to using the Generic Authentication Architecture to utilize the services in the home network and/or visited network for the UE is specified in the existing protocols, but no method is specified for managing the UE accessing networks by using the Generic Authentication Architecture. That is, the existing Generic Authentication Architecture can only authenticate whether the UE using a service is legal, but can not determine whether the UE is authorized to use the requested service. And it is unable to control the network service utilizing conditions of the UE when the UE accesses either the home network or the visited network.

### SUMMARY OF THE INVENTION

In view of the above, the present invention provides a method and a system for managing user equipment to access network by using Generic Authentication Architecture, so as to control the UE network service utilizing conditions.

The method in accordance with an embodiment of the present invention includes steps as follows. Upon receiving a service request which carries a Bootstrapping Transaction Identifier (B-TID) from an authenticated UE, a Network Application Function (NAF) sends a B-TID query request to a network function. The network function receives the B-TID query request from the NAF, and decides whether the UE initiating the service request is authorized to use a network service corresponding to the service request. If the UE is authorized to use the network service, the network function returns a successful query response including information needed by the NAF, and then the NAF controls the communication with the UE according to the received successful query response from the network function; otherwise, the network function returns a failed query response to the NAF and the NAF rejects the UE.

A system for managing UE to access networks by using Generic Authentication Architecture is also disclosed in the present invention. The system includes UE for sending a service request to a Network Application Function (NAF), the NAF for receiving the service request which carries a Bootstrapping Transaction Identifier (B-TID) from an authenticated UE, and sending a B-TID query request; and a network function for receiving the B-TID query request from the NAF and determining whether the UE initiating the service request is authorized to use the network service.

The basic technical solution of the present invention is described hereinafter. Upon receiving the B-TID query request from the NAF, the network function which is able to provide the query information determines whether the UE requesting for accessing the network is authorized to use the service in the network. If the UE is authorized, the network function returns to the NAF a successful query response carrying the information queried by the NAF, and then, the NAF communicates with the UE according to the successful query response; otherwise, the network function returns a failed query response to the NAF, and the NAF rejects the access action of the UE.

The present invention provides a method for managing user equipment to access networks using Generic Authentication Architecture so that the home network is able to control the network service utilizing conditions of the UE and avoids the cases that unauthorized UE may use the network services. Moreover, the visited network is also able to check whether the UE is authorized to use the service of the visited network so that the visited network is also able to perform better control and management to its own services. At the same time, because the returned failed query response carries the value of failure cause, proper operations may be carried out according to the failure cause, thereby avoiding consumption of network resources resulted from attempts in vain.

### BRIEF DESCRIPTION OF THE DRAWINGS

FIG. 1 is a schematic diagram illustrating a structure of Generic Authentication Architecture;

FIG. 2 is a schematic diagram illustrating a structure of the Generic Authentication Architecture when a UE uses a visited network service; and

FIG. 3 is a flowchart illustrating a preferred embodiment of the present invention.

### DETAILED DESCRIPTION OF THE INVENTION

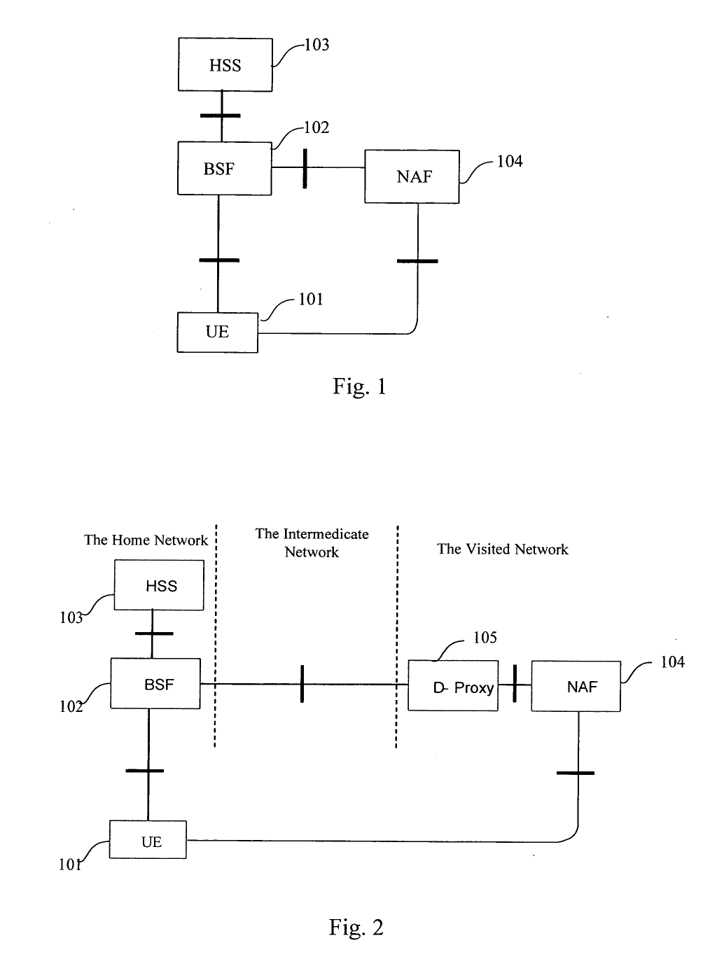

FIG. 2 shows a structure of the Generic Authentication Architecture when the UE accesses a visited network service. The structure shown in FIG. 2 is similar to the structure of FIG. 1 except for an additional Diameter Proxy (D-Proxy) 105. The D-Proxy may be a BSF in the visited network or a special proxy server in the visited network. All NAFs in the visited network are connected with the D-Proxy instead of being connected directly with the BSF in the home network. The home network is connected with the visited network through other networks such as a Virtual Private Network (VPN) and so on. A roaming UE still needs to perform an authentication with the home network BSF when the UE accesses a service of the visited network. The authentication process is identical to the process when the UE is in the home network.

In order to make the technical solution of the present invention more apparant, the present invention will be described in detail hereinafter with reference to the accompanying drawings.

In the present invention, upon receiving a B-TID query request from a NAF, a network function which is able to provide the query information determines whether the UE requesting for accessing the network is authorized to use the service in the network. If the UE is authorized, the network function returns to the NAF a successful query response carrying the information queried by the NAF, and then, the NAF communicates with the UE according to the successful query response; otherwise, the network function returns a failed query response to the NAF, and the NAF rejects the access of the UE.

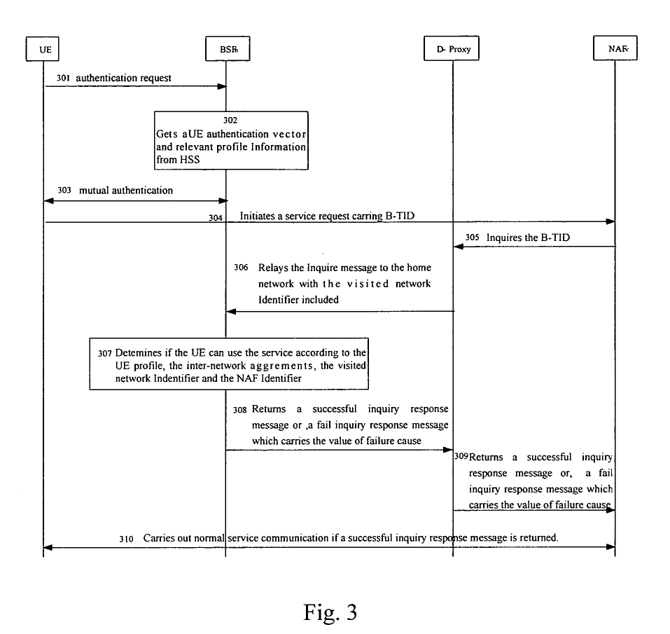

Referring to FIG. 3, in this embodiment, a roaming UE intends to use a service in a visited network. As shown in FIG. 3, BSFₕ in the chart denotes a home network BSF, and NAFᵥ denotes a visited network NAF. Detailed description about the flow chart of the present embodiment now is given as follows.

Steps 301˜303, when the roaming UE intends to use a service in the visited network, the UE sends an authentication request to the home network BSF. Upon receipt of the authentication request, the home network BSF sends a request to a HSS for getting a UE authentication vector and relevant Profile information. Subsequently, the BSF performs mutual authentication with the UE. The BSF and the UE share a shared key Ks therebetween upon being successfully authenticated. At the same time, the UE gets the B-TID allocated by the BSF.

It should be noted that if the UE has already got the B-TID in advance, the above steps may be skipped and starts Step 304 may be performed directly.

Steps 304˜305, the UE sends a service request carrying the B-TID to the visited network NAF denoted with NAFv. Upon receipt of the service request, the visited network NAF sends a query request to a diameter proxy (D-Proxy) in the visited network. The query request carries a NAF identifier and the B-TID.

Step 306, upon successfully authenticating the NAF, the D-Proxy carries out one of the two following processing ways:

The D-Proxy may send a message carrying the query request and a visited network ID to the home network BSF denoted with BSFₕ, and then may perform subsequent steps.

Or, the D-Proxy may decide whether the UE initiating the service request is authorized to use the requested service. If the UE is authorized, the D-Proxy may send a message carrying the query request and the visited network ID to the home network BSF, and then proceeds with the succeeding steps. If the UE is not authorized to use the service, the D-Proxy may send a failed query response to the NAF instead of sending the query message to the home network BSF. The failed query response carries a value of a failure cause. Upon receiving the failed query response, the NAF rejects the access of the UE and terminates the process.

The process of deciding whether the UE initiating the service request is authorized to use the requested service includes following procedures. The D-Proxy decides whether there are inter-network agreements and service agreements between the home network and the visited network. If there are inter-network agreements and service agreements, the D-Proxy determines that the UE is authorized to use the service; otherwise, the UE initiating the service request cannot use the requested service. If there are inter-network agreements and service agreements between the home network and the visited network, the process of the D-Proxy deciding whether the UE initiating the service request is authorized to use the requested service may further include following procedures. The D-Proxy decides if the NAF that the UE sends request to is currently able to provide a service for the UE. For example, if the requested service is special and is only provided to the UE in the visited network, or, if the NAF is currently busy and provides service to the UE in the visited network preferably, the D-Proxy determines the NAF that the UE sends request to is unable to provide a service to the UE. If the D-Proxy determines the NAF that the UE sends request to is able to provide service to the UE currently, the UE is authorized to use the service; otherwise, the UE is not authorized to use the service.

The advantages of the D-Proxy carrying out the above processes is that the visited network is also able to determine whether to allow the UE using its service, so that the visited network may perform better control and management on its own services.

Steps 307˜308, Upon having received the query message from the D-Proxy, the BSFₕ extracts the B-TID, the visited network identifier and the NAF identifier, and then decides whether there are inter-network agreements and service agreements between the home network and the visited network. Generally, the BSFₕ determines whether the UE is authorized to use the service in the visited network by checking the UE specific Profile, i.e., the specific contents in the USS, or by checking a list such as a black list used to indicate the UE credibility and/or authority, or by any combination of the above. Only when the UE is authorized to use the service, the BSFₕ works out the derived key Ks-NAF according to such information as the B-TID found locally and the shared Ks, and then, returns a successful query response to the D-Proxy. The successful query response carries the B-TID and the Ks-NAF corresponding to the B-TID. Moreover, the BSFₕ may also return the USS or a part of the USS required by the service requires according to the operator's policy configured at the BSF so as to the NAF may use the USS.

If the UE is not authorized to use the service, the BSFₕ returns a failed query response which carries the value of failure causes to the D-Proxy. The failure causes may include causes as follows. There are no relevant service agreements between the home network and the visited network, or there are service agreements between the home network and the visited network, but they do not include the service requested by the UE, or the service that the UE requested is not supported although there are service agreements between the network and the visited network, or the UE is not authorized to use the service although there are service agreements between the network and the visited network, or the B-TID belongs to the UE is invalid, or any combination of the above. The failed query response which carries the value of the failure cause is for the purpose that the UE can directly carry out proper operations according to the failure cause upon it receives the failure message; thereby avoiding consumption of network resources resulting from attempts in vain.

The agreements and the check policy between the home network and the visited network may be preconfigured in the BSF, or maybe downloaded by the BSFₕ from the HSS.

Step 309, the D-Proxy relays a successful query response or a failed query response to the NAF initiating the query request. If the NAF receives the failed query response, the NAF sends a reject message carrying the value of the failure cause to the UE to indicate that the UE is unable to use the service, i.e., the UE is rejected to access the network. And then, the NAF terminates the process.

The NAF performs Step 310 when receives the successful query response.

Step 310, The NAF communicates with the UE under protection of the key of Ks_NAF.

As mentioned above, the BSFₕ may be regarded as a network function providing query information. Those skilled in the art should understand that, the network function providing query information also may be a logic function including the BSF of the home network and a gateway function. The home network connects with the visited network through the gateway function. The gateway function may be a function which already exists in the existing networks, or a proxy function that is independently set up.

If the network function providing query information is a logic function including the home network BSF and the gateway function, the network function carries out check operation upon receiving query request from the D-Proxy. For instance, the network function checks whether there are inter-network agreements and service agreements between the UE's home network and the visited network. If there are inter-network agreements and service agreements, the gateway function relays the query request message to the BSF, and the BSF proceeds with the succeeding steps such as searching the B-TID, generating key information, and so on. If there are not inter-network agreements and service agreements, the gateway function may directly return a failed query response carrying the value of the failure cause to the D-Proxy. If the gateway function needs to implement the check functions on the UE, the relevant information, such as the B-TID and the UE identifier, should be preconfigured in the gateway function. Therefore, the gateway function may get true identity of the UE so as to facilitate acquiring the UE Profile information. The advantage of using the gateway function for accomplishing the check operation is to decrease the load of the BSF.

Though the above embodiments describe the scenario when the UE uses a service of the visited network, the control mechanism is also applicable when the NAF locates in the home network. In the latter case, the BSF needs not to check the inter-network agreements because the BSF and the NAF are both in the home network. But other contents can still be checked according to the operator's policy. Additionally, the BSF may communicate with the NAF of the home network directly without any other intermediate functions.

The foregoing is only the preferred embodiment of this invention and is not for use in limiting this invention. The invention is to cover all the modifications, variations and equivalent replacements within the spirit and scope of the disclosure as defined by the appended claims.

What is claimed is:

1. A method for managing user equipment (UE) to access networks by using Generic Authentication Architecture, comprising:
upon receiving a service request which carries a Bootstrapping Transaction Identifier (B-TID) from an authenticated UE, a Network Application Function (NAF) sending a B-TID query request to a network function; and
the network function receiving the B-TID query request from the NAF, deciding whether the UE initiating the service request is authorized to use a network service corresponding to the service request, if the UE is authorized to use the network service, the network function returning a successful query response including information needed by the NAF, and then the NAF controlling the communication with the UE according to the received successful query response from the network function; otherwise, the network function returning a failed query response to the NAF and the NAF rejecting the UE.

2. A method according to claim 1, wherein the UE initiating the service request belongs to a home network; the NAF belongs to a visited network; and
wherein the network function receives the B-TID query request from the NAF of the visited network, the B-TID query request is relayed by a Diameter Proxy (D-Proxy) belonging to the same visited network, and the network function sends the successful query response or the failed query response to the visited NAF through the D-Proxy.

3. A method according to claim 2, wherein the process of the network function deciding whether the UE initiating the service request is authorized to use the network service comprises one of:
the network function determining whether there are inter-network agreements and service agreements; and
the network function determining whether the UE is authorized to use the service according to at least one of UE profile information and a list for indicating the UE credibility and/or authorizations; and
if there are inter-network agreements and service agreements and the UE is authorized to use the service, the UE can use the service in the visited network; otherwise, the UE can not use the service in the visited network.

4. A method according to claim 2, before the process of the D-Proxy in the visited network relaying the B-TID query request further comprising: the D-Proxy determining whether the UE can use the service in the visited network, if the UE can use the service in the visited network, the D-Proxy relaying the B-TID query request to the network function; otherwise, the D-Proxy returning a rejecting access message to the NAF to indicate that the service is not allowed for the UE.

5. A method according to claim 4, wherein the rejecting access message carries a value of a failure cause.

6. A method according to claim 4, wherein the process of the D-Proxy determining whether the UE can use the service in the visited network comprises: the D-Proxy determining whether there are inter-network agreements and service agreements between the visited network and the home network, if there are inter-network agreements and service agreements between the visited network and the home network, the D-Proxy determining that the UE can use the service in the visited network, otherwise, the D-Proxy determining that the UE cannot use the service in the visited network.

7. A method according to claim 6, upon the process of the D-Proxy determining that there are inter-network agreements and service agreements between the visited network and the home network further comprising: the D-Proxy determining whether the NAF is currently able to provide a service for the UE, if the NAF is currently able to provide a service the UE, the D-Proxy determining that the UE can use the service in the visited network, otherwise, the D-Proxy determining that the UE cannot use the service in the visited network.

8. A method according to claim 2, wherein the failed query response includes a value of a failure cause.

9. A method according to claim 2, wherein the network function comprises one of a home network Bootstrapping Server Function (BSF) and a logical function comprising a BSF in the home network and a gateway function between the home network and the visited network.

10. A method according to claim 1, wherein the UE belongs to a home network and the NAF belongs to the same home network; the network function directly receives the B-TID query request from the NAF and directly returns the successful query response or the failed query response to the NAF.

11. A method according to claim 10, wherein the process of the network function deciding whether the UE initiating the service request is authorized to use the network service comprises one of:
the network function determining whether there are inter-network agreements and service agreements; and
the network function determining whether the UE is authorized to use the service according to at least one of UE profile information and a list for indicating the UE credibility and/or authorizations; and
if there are inter-network agreements and service agreements and the UE is authorized to use the service, the UE can use the service in the visited network; otherwise, the UE can not use the service in the visited network.

12. A method according to claim 10, wherein the failed query response directly returned by the network function to the NAF of the home network carries a value of a failure cause.

13. A method according to claim 10, wherein the network function is a BSF of the home network.

14. A system for managing user equipment (UE) to access networks by using Generic Authentication Architecture, comprising:
UE for sending a service request to a Network Application Function (NAF);
the NAF for receiving the service request which carries a Bootstrapping Transaction Identifier (B-TID) from an authenticated UE, and sending a B-TID query request; and
a network function for receiving the B-TID query request from the NAF and determining whether the UE initiating the service request is authorized to use the network service.

15. A system according to claim 14, wherein the UE belongs to a home network, the NAF belongs to a visited network, and the system further comprising a Diameter Proxy (D-Proxy); wherein the D-Proxy relays the B-TID query request from the visited NAF to the network function, and the network function sends a successful query response or a failed query response to the visited NAF through the D-Proxy.

16. A system according to claim 15, wherein the network function comprises one of a home network Bootstrapping Server Function (BSF) and a logical function comprising a BSF in the home network and a gateway function between the home network and the visited network.

17. A system according to claim 14, wherein the UE belongs to a home network and the NAF belongs to the same home network.

18. A system according to claim 17, wherein the network function is a BSF of the home network.
